(19) United States
(12) Patent Application Publication
(10) Pub. No.: US 2004/0139571 A1
(43) Pub. Date: Jul. 22, 2004

(54) Portable cart for mobile computer classrooms

(76) Inventors: Li-Jie Chang, Taichung City (TW); Tai-Wai Chan, Jungli City (TW); Yi-Chan Deng, Dadu Shiang (TW); Hsue-Yie Wang, Taipei City (TW); Jen-Kai Liang, Tucheng City (TW)

Correspondence Address: BIRCH STEWART KOLASCH & BIRCH, PO BOX 747, FALLS CHURCH, VA, 22040-0747, US

(21) Appl. No.: 10/744,217

(22) Filed: Dec. 23, 2003

(30) Foreign Application Priority Data
Jan. 16, 2003 (TW) 092100867

(51) Int. Cl. B60S 1/54; B60S 1/64; A47L 5/38; A47L 15/00

(52) U.S. Cl. 15/315

(57) ABSTRACT

A portable cart for mobile computer classroom is disclosed, which installs a plurality of computers and electronic devices on a mobile vehicle so that a computer classroom can be set up anywhere. The portable cart includes a first computer, a plurality of second computers, a power supply device, a network hub, a projector, a central control computer, and a wireless network access point. The first computer is used by teachers for teaching, and the second computers are portable computers with wireless transmission capability. When the second computers are not in use, they are placed at a slot rack which is wired for electrical recharging. The power supply device further comprises a recharge device and a plug, wherein the plug can be plugged in the electrical power outlet to provide power to the first computer and the electronic devices installed in the portable cart, and can recharge the second computers through the recharge device. The network hub is used for connecting the first computer, the second computers, and other electronic devices. The projector is used to project the screen of the first computer or any specific second computers onto a screen. The central control computer is used to control the synchronous or asynchronous teaching. The wireless network access point provides the first computer and the second computers a wireless network access point.

### FIELD OF THE INVENTION

This invention relates to a computer-related device and, more particularly, to a portable cart that can be used as a mobile computer classroom to provide a modular environment for teaching activity.

### BACKGROUND OF THE INVENTION

A conventional computer classroom is usually a room that is equipped with a plurality of computers connected with fixed routing facility so that the teacher and a number of students can conduct the teaching and learning using those computers. FIG. 1 shows a typical layout of a computer classroom, where a plurality of computers 11 and at least a synchronized screen controller 13 are in a specific space 10. The computers 11 are for the teacher and the students, and the synchronized screen controller 13 is for the teachers. The fixed routing circuit 15 provides the computers 11 and the synchronized screen controller 13 power and transmission medium so that the teaching activity between the teacher and the students can be conducted. The fixed routing circuit 15 comprises power lines, screen signal lines, and network lines.

Because the computers and the routing circuit in the classroom shown in FIG. 1 are both fixed, the teaching needs to be conducted at a fixed location, and provides little flexibility for group demonstration or related teaching activities. The present invention aims to rectify the above restriction.

### SUMMARY OF THE INVENTION

The objective of the present invention is to provide a portable cart that can be used to set up a mobile computer classroom to solve the aforementioned problem. The present invention, a portable cart for mobile computer classroom, is to install a plurality of computers and electronic devices on a mobile vehicle so that a computer classroom can be set up anywhere. The portable cart comprises a first computer, a plurality of second computers, a power supply device, a network hub, a projector, a central control computer, and a wireless network access point. The first computer is used by teachers for teaching and the second computers are portable computers with wireless transmission capability. When the second computers are not in use, they are placed at a slot rack which is wired for electrical recharging. The power supply device further comprises a recharge device and a plug, wherein the plug can be plugged in the electrical power outlet to provide power to the first computer and the electronic devices installed in the portable cart, and can recharge the second computers through the recharge device. The network hub is used for connecting the first computer, the second computers, and other electronic devices. The projector is used to project the screen of the first computer or any specific second computers onto a screen. The central control computer is used to control the synchronous or asynchronous teaching. The wireless network access point provides the first computer and the second computers a wireless network access point.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows the layout of a conventional computer classroom.

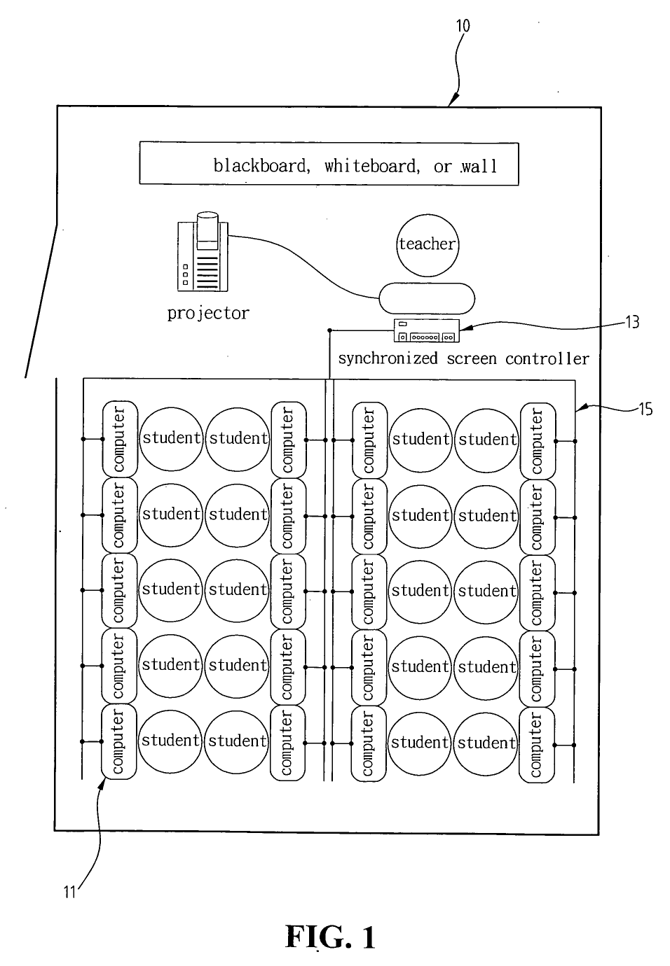

FIG. 2 shows an environment in which the present invention can be used.

FIG. 3 shows the hardware structure of the embodiment of the present invention.

FIG. 4 shows the recharge device of the embodiment of the present invention.

FIG. 5 shows the slide-stop and its manual operation of the embodiment of the present invention.

FIG. 6 shows the slide table and the equipment elevator operation of the embodiment of the present invention.

### DETAILED DESCRIPTION OF THE PREFERRED EMBODIMENT

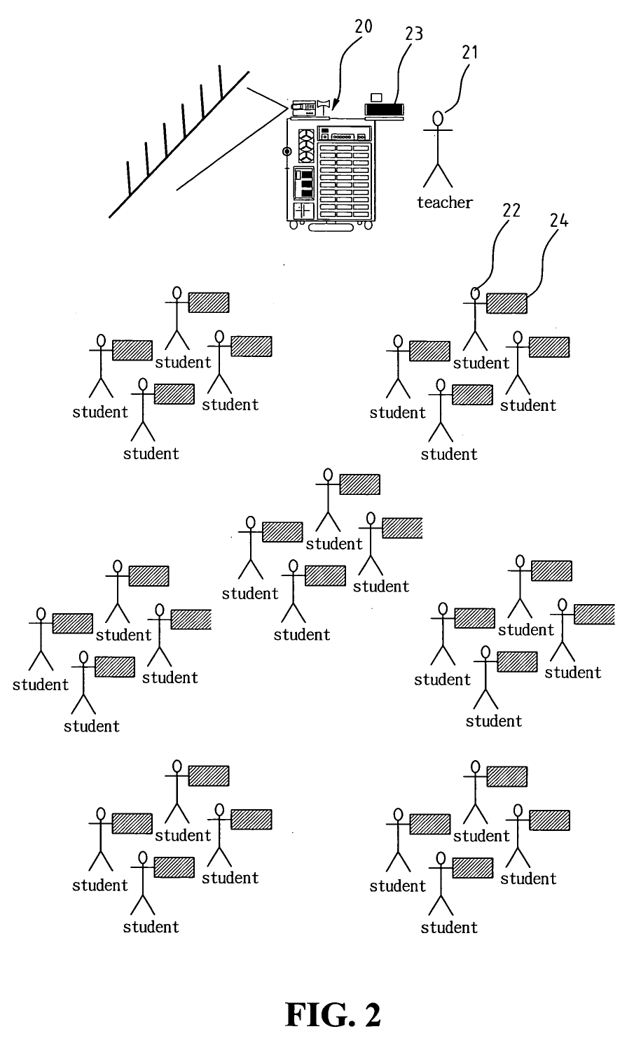

FIG. 2 shows an environment where the present invention is in use. The portable cart 20 is a mobile vehicle on which a plurality of computers and electronic devices are installed so that a mobile computer classroom can be set up anywhere to enable the teacher 21 and a plurality of students 22 to conduct the teaching activity. The computer 23 used by the teacher 21 is installed on the vehicle, and the computers 24 used by the students 22 are portable computers with wireless transmission capability. The computers 24, when not in use, are placed on the vehicle for recharge through the power supply device installed on the vehicle; when in use, they can be removed from the vehicle, and placed at arbitrary locations.

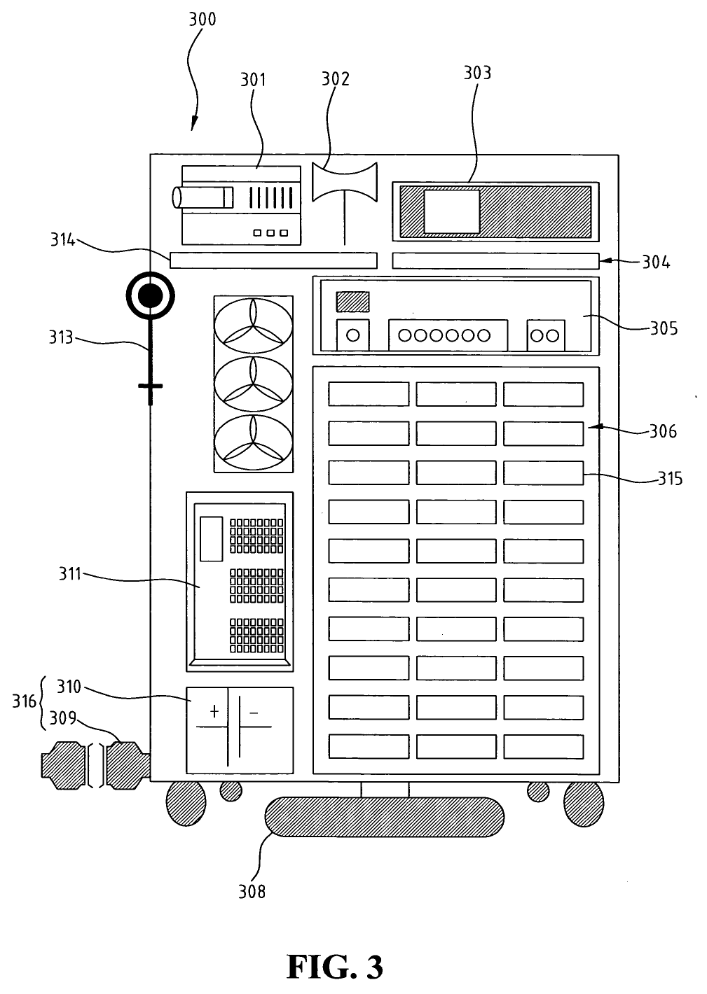

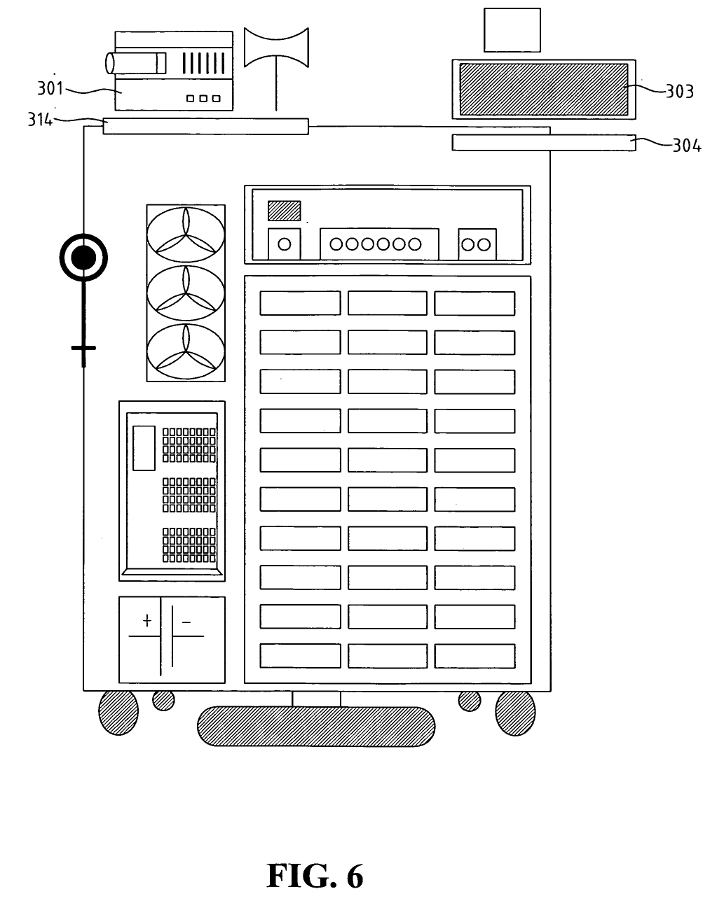

FIG. 3 shows the hardware structure of the embodiment of the present invention. The portable cart 300 comprises a projector 301, a wireless network access point 302, a first computer 303, a plurality of second computers 315, a computer slot rack 306, a power supply device 316, a network hub 305, and a central control computer 311. The portable cart 300 can further comprises a slide table 304, used to support the first computer 303, and can slide outward to form a table for the teacher to use (see FIG. 6).

The first computer 303 is the computer used by the teacher, and the second computers 315 are portable computers with wireless transmission capability. When the second computers 315 are not in use, they are placed at the slot rack 306 on the vehicle, and the power supply device 316 can recharge them through the slot rack 306. The number of the second computers 315 depends on the needs of the class. Generally, it is sufficient to have about 30 to 40 computers for a class.

The power supply device 316 further comprises a recharge device 310 and an electrical plug 309. The electrical plug 309 can be plugged into the power outlet to provide power to the first computer 303 and the electronic devices on the cart 300, as well as recharge all the second computers 315 simultaneously through the recharge device 310.

The network hub 305 is used to connect the first computer 303, the second computers 315 and other electronic devices on the portable cart 300. The projector 301 can project the screen of the first computer 303 or any specific second computer 315 onto a large screen, such as a wall or a display screen. The projector 301 is placed on an equipment elevator 314. The vertical projection position of the projector 301 can be adjusted by the operation of equipment elevator 314 (see FIG. 6).

The central control computer 311 is to control the synchronous or asynchronous teaching. The wireless network access point 302 is to provide wireless network access to the first computer 303 and the second computers 315.

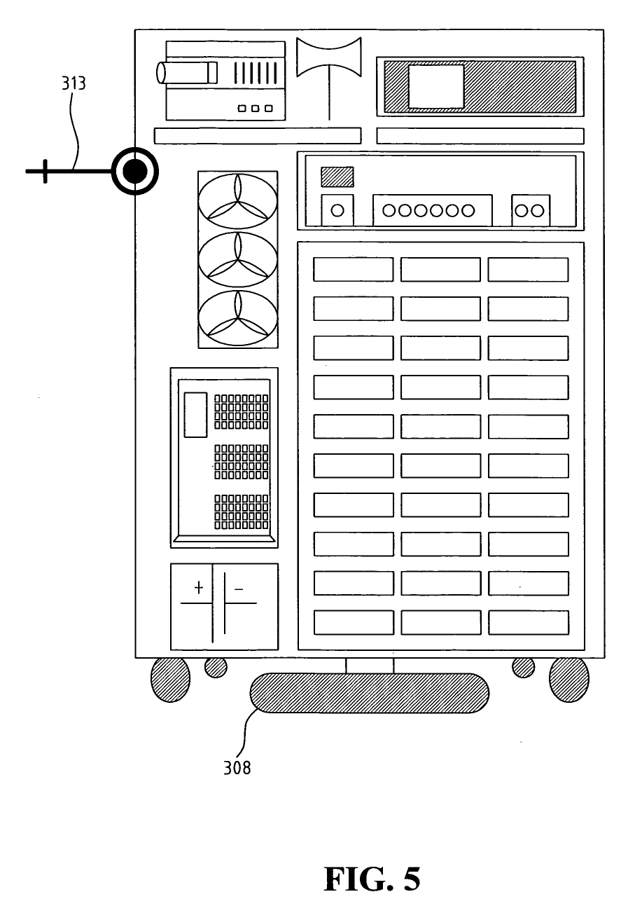

The portable cart 300 can further comprises a slide-stop device, comprised of a slide-stop board 308 and a slide-stop lever 313. The slide-stop board 308 is installed at the bottom of the vehicle of the portable cart 300. When it is pushed downwards from the bottom, it will touch the ground and stop the portable cart 300 from sliding. As shown in FIGS. 3 and 5, the slide-stop lever 313 is used to control the movement of the slide-stop board 308. When it is pulled downwards, the slide-stop board 308 is pushed downwards to prevent the portable cart 300 from sliding (see FIG. 3). When the lever 313 is in a horizontal position, the slide-stop board is retracted and the portable cart is mobile (see FIG. 5).

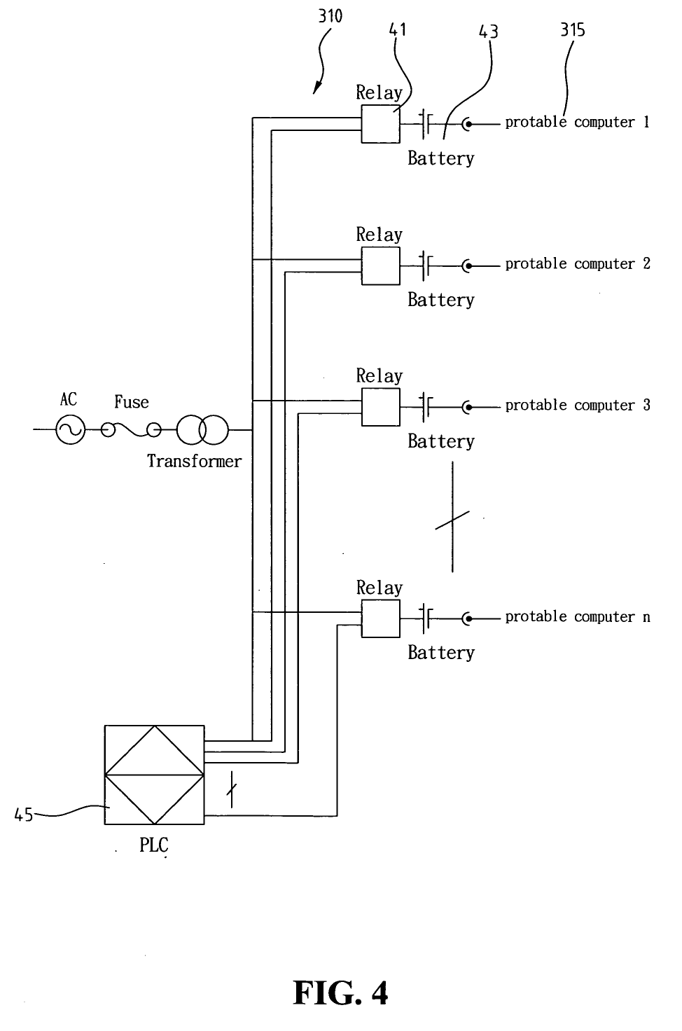

FIG. 4 shows the circuit of the recharge device of the present invention. The recharge device 310 comprises a plurality of relays 41, a plurality of batteries 43, and a programmable controller 45. Each relay 41 is connected to a second computer 315, so that it can control the current from the plug 309 (see FIG. 3) into the second computer 315. The batteries 43 are used to store the electrical power from the plug 309 (see FIG. 3), so that they can adjust the output current to the second computer 315. Therefore, the recharge device can simultaneously recharge a plurality of second computers. The programmable controller 45 is used to control relays 41, so that the relays 41 can be activated in a specific pre-set order.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A portable cart for mobile computer classroom, which is to install a plurality of computers and electronic devices on a mobile vehicle so that a computer classroom can be set up in an arbitrary space, said portable cart comprising:
a first computer adapted to be used by the teacher;
a plurality of second computers, which are portable computers with wireless transmission capability;
a power supply device, which comprises a recharge device and a plug, wherein said plug can be plugged into power outlet to provide power to said first computer and other electronic devices, as well as recharge said second computers;
a slot rack, for placing said second computers when not in use, and also connected to said power supply device to provide recharging to said second computers;
a network hub, for connecting said first computer, said second computers, and other electronic devices;
a projector, for projecting the screen of said first computer or a specific said second computer onto a large screen;
a central control computer, for controlling synchronous or asynchronous teaching activity; and
a wireless network access point, used to provide said first computer and said second computers with wireless network access.

2. The portable cart as claimed in claim 1, wherein said portable cart further comprising a slide table for supporting said first computer, and serving as a table for teacher when slide outwards.

3. The portable cart as claimed in claim 1, wherein said recharge device further comprising:
a plurality of relays, wherein each said relay is connected to a said second computer, so that said relay can control the current from said plug into said second computer;
a plurality of batteries, wherein each said battery is connected to a said second computer, so that said battery can store the power from said plug, and can adjust the output current to said second computer to enable recharge a plurality of second computer simultaneously; and
a programmable controller, used to control said relays so that said relays can be activated in a preset order.

4. The portable cart as claimed in claim 1, wherein said portable cart further comprises a slide-stop device, said slide-stop device comprising:
a slide-stop board, installed at the bottom of said portable cart, and when pushed downwards, said slide-stop board touches the ground, and prevents said portable cart from sliding; and
a slide-stop lever, for controlling the movement of the slide-stop board, wherein when pulled downwards, said slide-stop board was pushed downwards to prevent said portable cart from sliding, and when said slide-stop lever is in horizontal position, said slide-stop board is retracted so that said portable cart is mobile.
